(19) United States
(12) Patent Application Publication
(10) Pub. No.: US 2011/0283949 A1
(43) Pub. Date: Nov. 24, 2011

(54) PET WASTE DISPOSAL SYSTEM AND METHOD

(76) Inventor: Paul Kelly, Benbrook, TX (US)

(21) Appl. No.: 12/905,758

(22) Filed: Oct. 15, 2010

Related U.S. Application Data
(60) Provisional application No. 61/347,504, filed on May 24, 2010.

(51) Int. Cl. A01K 29/00

(52) U.S. Cl. 119/161

(57) ABSTRACT

The outdoor pet waste disposal system comprises a receptacle for collecting the waste and a volume of flushing fluid, a flushing valve member, a one-way valve member to prevent cross contamination, a trap, and a plumbing stub whereby the waste and flushing fluid is flushed in a siphon-type action into a sewer line.

The method of disposing of pet waste comprises the steps of providing an outdoor pet waste disposal apparatus comprising a receptacle, an inlet conduit coupled to the receptacle, a one-way valve, a volume of flushing fluid, a flushing valve, an outlet conduit having a hydrostatic seal, said outlet conduit being coupled to the receptacle and a sewer; placing a volume of pet waste into said receptacle; filling the receptacle with flushing fluid; opening the flushing valve to allow the pet waste to exit the receptacle through the outlet conduit into the sewer.

### BACKGROUND OF THE INVENTION

1. Field of the Invention

The present invention relates to pet waste disposal systems, and in particular, to systems for delivering pet waste into a sewer line for disposal.

2. Description of the Prior Art

There has long been a need for an apparatus that can be installed outside the home or other building, whereby pet waste can be conveniently and safely disposed of through the sewer system. Most municipalities and other water-regulating authorities have adopted the Uniform Building Code, which includes strict guidelines about how pet waste and other waste can be collected and disposed of through local sewage systems. It is necessary that any pet waste disposal system conform to these guidelines, especially as they pertain to maintaining a hydrostatic seal between the outside air and the sewer system, to preventing the release of sewer gases, and to preventing the risk of cross contamination. The need is especially present at apartment buildings and other multi-family units where many families and pets share common exterior spaces.

Abandoned U.S. Pat. No. 5,070,820 issued to Gorman discloses a pet waste disposal device for installation outside a home or other building that incorporates a funnel-shaped receptacle for attachment to a sewer line clean out fitting. The Gorman device includes a valve to which a garden hose is connected. The purpose of the valve is to adjust how the water sprays through the inlet into the receptacle. Although the Gorman device provides a way to dispose of pet waste through a sewer line, it has several critical shortcomings. First, it lacks a means of creating a hydrostatic seal between the outside air and the sewer system. Second, it fails to provide a way to create a siphon-type flushing action. Third, its construction does not conform to the strict guidelines set forth in the Uniform Building Code, in that it does not include a one-way valve between the source of pure water (the garden hose) and the sewer line. Without this critical component, the user runs a risk of cross contamination.

The present invention satisfies the need for an outdoor pet waste disposal system, and provides many advantages over the prior art. It is a unique apparatus that can be quickly and easily installed on the outside of the home or other building. It is adapted to be installed onto the clean out fitting (plumbing stub) of an existing home or building, or as part of a new construction. The present invention conforms to the strict guidelines of the Uniform Building Code, and provides a safe and convenient way to collect and flush pet waste and other waste into a sewer line. It includes a plurality of hydrostatic seals between the outside air and the sewer system. It creates a volume of flushing fluid so that a siphon-type flushing action is achieved. Its construction also includes a one-way valve between the source of flushing fluid and the sewer line so that there is no risk of cross contamination.

The present invention includes the advantage of having a foot pedal which allows hands-free operation of the flushing fluid. The foot pedal opens and closes the one-way valve allowing the volume of flushing fluid to accumulate in the receptacle. A flushing valve opens and closes to allow the waste and flushing fluid to be flushed in a siphon-type action into the sewer line. In one embodiment of the present invention, the flushing valve is hand operated. In another embodiment, the flushing valve is operated by a motor through an electrical connection. In one aspect of the invention, the apparatus is coupled to a plumbing stub below ground level. In another aspect, the apparatus is coupled to a plumbing stub above ground level.

These, as well as other advantages of the present invention are apparent in the following description and drawings.

### SUMMARY OF THE INVENTION

The present invention provides an outdoor pet waste disposal apparatus that can be quickly and easily installed onto a clean out fitting (plumbing stub) of a home or other building. The apparatus comprises a receptacle for collecting the waste and a volume of flushing fluid, a self-cleaning flushing valve member, a one-way valve member to prevent cross contamination, and a hydrostatic seal between the outside air and the sewer, whereby the waste and flushing fluid is flushed in a siphon-type action into the sewer.

In another aspect of the invention, the inward flow of flushing fluid into the receptacle is controlled by a foot pedal. In another aspect of the invention, the apparatus may be coupled to either a below ground plumbing stub or an above ground plumbing stub. In another aspect of the invention, the apparatus is comprised of a hand operated flushing valve. In another aspect of the invention, the apparatus is comprised of a motor driven flushing valve. In still another aspect of the invention, the flushing valve is solar powered.

The invention also provides a method for disposing of pet waste comprising the steps of: providing an outdoor pet waste disposal apparatus comprised of a receptacle, an inlet conduit coupled to the receptacle, a one-way valve, a volume of flushing fluid, an outlet conduit having a flushing valve and a trap, said outlet conduit being coupled to the receptacle and a sewer line; placing a volume of pet waste into said receptacle; filling the receptacle with flushing fluid; opening the flushing valve to allow the pet waste to exit the receptacle through the waste conduit into the sewer line.

### BRIEF DESCRIPTION OF THE DRAWINGS

FIG. 1A is an elevation view of the pet waste disposal apparatus of the present invention in accordance with a preferred embodiment.

FIG. 1B is an elevation view of an alternate embodiment of the pet waste disposal apparatus of FIG. 1A.

FIG. 2A is an elevation view of the pet waste disposal apparatus of the present invention in accordance with another embodiment.

FIG. 2B is an elevation view of alternate embodiment of the pet waste disposal apparatus of FIG. 2A.

FIG. 3 is a cutaway view along the line III-111 of FIG. 1A.

### DESCRIPTION OF THE PREFERRED EMBODIMENT

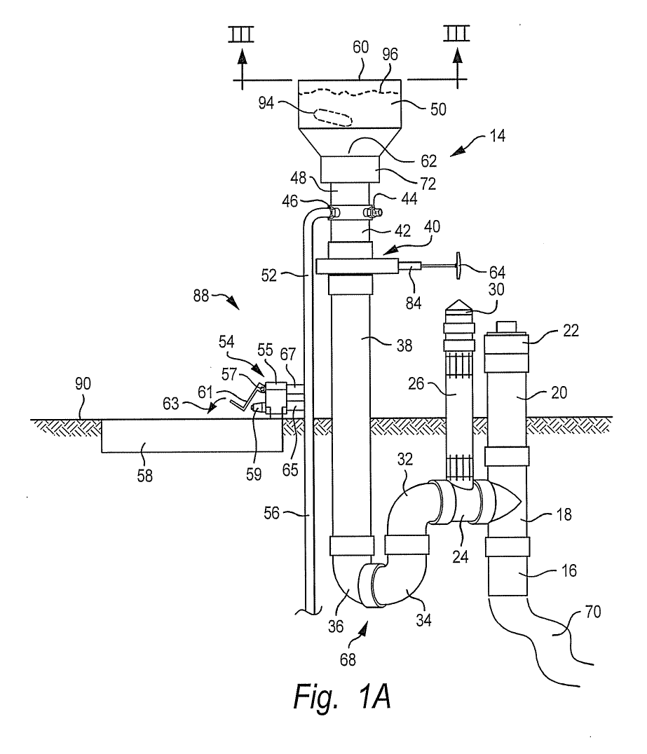

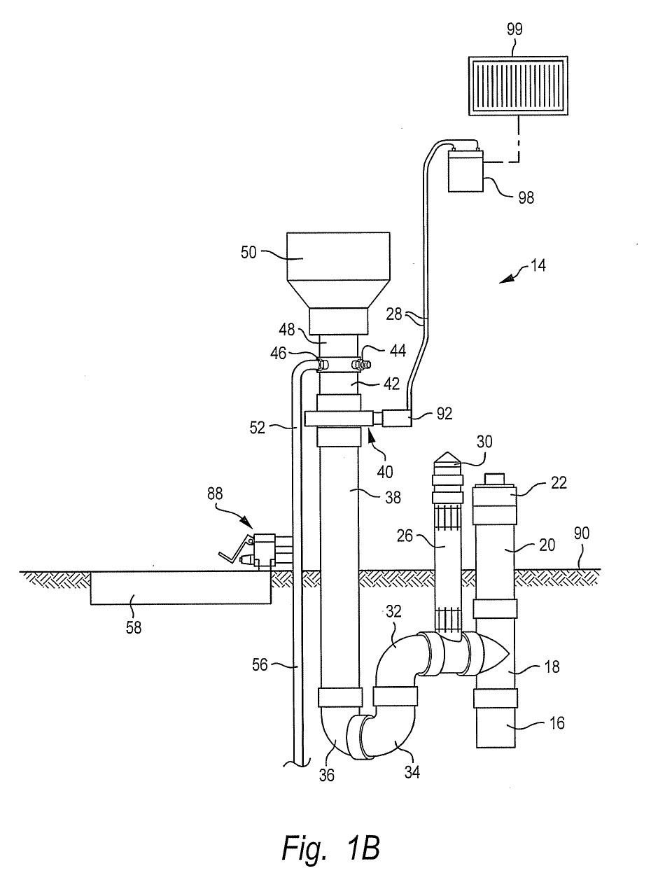

Referring to FIGS. 1A and 1B in the drawings, numeral 14 illustrates the preferred embodiment of the pet waste disposal apparatus 14 of the present invention. As shown, it is an aspect of the invention to provide an outdoor pet waste disposal apparatus 14 that may be coupled to a below ground clean out fitting 16 or “plumbing stub” 16. Apparatus 14 has a receptacle member 50 having an open upper portion 60 and an open lower portion 62. Upper portion 60 and lower portion 62 are preferably circular in cross-section, but may be of any geometric cross-section. Upper portion 60 is of larger diameter than lower portion 62, and as a result, receptacle member 50 tapers inwardly from upper portion 60 to lower portion 62. The taper leads downward to lower basin 72. Although receptacle member 50 is depicted in FIG. 1 as conical, tapering linearly to a lower basin 72, it should be understood that receptacle member 50 may be of any suitable geometric cross-section, such as elliptical, provided that upper portion 60 remains generally structured to allow fluid 96 and waste 94 to gravitationally flow towards lower portion 62. Receptacle member 50 is preferably made of polyvinylchloride (PVC), but may be made from metal, such as stainless steel, or any other rigid material that is water and corrosion resistant.

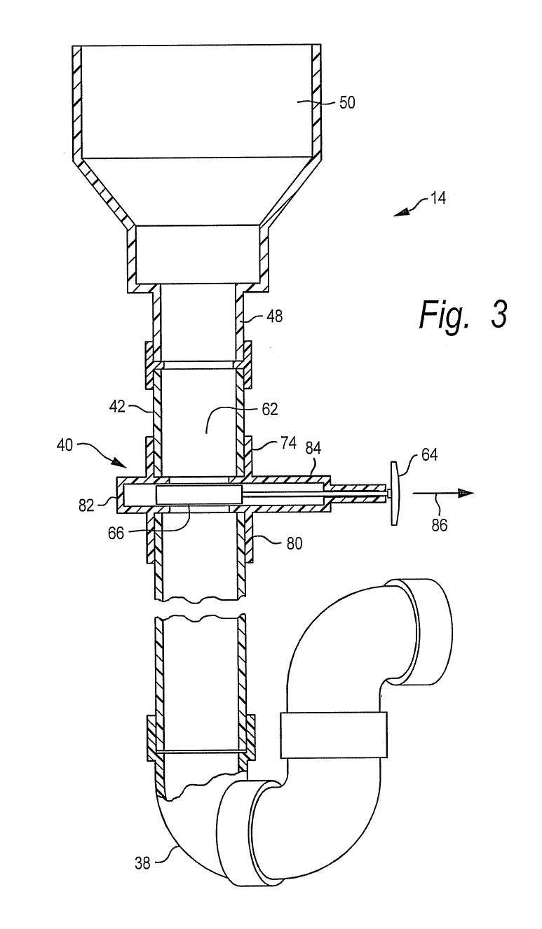

Referring to FIG. 3, receptacle member 50 is sealingly coupled to a flush valve member 40. Flush valve member 40 is preferably a conventional and commercially available self-cleaning T-valve. Flush valve member 40 is operable between a closed position and an open position by manual operation of a T-bar handle member 64. T-bar handle member 64 is attached to a sliding valve plate 66. The construction and operation of flush valve member 40 will be described in more detail below.

Referring now specifically to FIG. 1A in the drawings, a waste conduit member 38 is sealingly coupled to flush valve member 40. Conduit member 38 has a trap 68 to provide a hydrostatic seal between the outside air and the sewer line. Trap 68 is comprised of curved members 34 and 36. Conduit member 38 is adapted to be sealingly connected via connectors 68, 32, 24, and 18 to a conventional plumbing stub 16 of a sewer line 70 that runs below ground level 90. As shown in the figures, outlet conduit member 38 may include various conventional adapters 36, 34, 32, 24, 18, 20, 68, 26, and 30 for quick and easy connection to plumbing stub 16. Plumbing stub 16 typically extends through an exterior wall of a home or other building. It should be understood that plumbing stub 16 is typically coupled to clean out riser 20 which may have a cap or plug 22, as is conventional in the plumbing and construction industries. In this manner, apparatus 14 may be quickly and easily installed on the exterior of the existing sewer system of a home or building. In the preferred embodiment, the apparatus 14 is further comprised of a vent 30 coupled to the outlet conduit 38, 24 by riser 26 between the trap 68 and the sewer 70 line. This vent 30 is conventional and commercially available and, in the preferred embodiment is a Studo® vent 30. This vent 30 allows gases from the sewer line 70 to escape and permits the trap 68 to remain at near atmospheric pressure.

Referring now specifically to FIG. 1B, an alternative embodiment of the present invention is shown. All elements of the embodiment depicted in FIG. 1B are identical to the corresponding elements of like numerals in FIG. 1A, with the exception that flushing valve 40 is controlled with an electric motor 92 rather than by hand. Electric flushing valve 92 is conventional and commercially available and capable of being operated with a variety of voltages, including, but not limited to 12 and 120 volts. Said motor 92 is powered by an electrical power source 98 connected with electrical connectors 28. The power source 98 may provide 12, 120, or other voltage to the motor 92, depending upon the motor 92 selected. The motor 92 selection will depend, of course, on the power source 98 available near the apparatus 14. The power source 98 may be a battery 98, power from the structure, or some other source 98 of power. In a preferred embodiment, the power source 98 is a battery 98. As shown in FIG. 1B, in one aspect of the invention, the battery 98 is charged by solar panel 99. Battery 98 and solar panel 99 permits the device 14 to be mounted in areas that are distant from other power sources 98. Also, the case of a battery 98 and solar panel 99 allow a user to power the device 14 without having to modify the wiring of the structure.

Referring now to FIG. 3 in the drawings, a portion of apparatus 14 of FIG. 1A is depicted in cross-section taken at III-III of FIG. 1A. A tubular first coupling member 74 is integrated within flash valve member 40 is coupled to pipe spacers 42 of receptacle 50. First coupling member 74 may be integrated into either pipe spacers 42 or flush valve member 40. A tubular second coupling member 80 integrated within flash valve member 40 is coupled to pipe riser 38. Second coupling member 80 may be integrated into either flush valve member 40 or pipe riser 38. T-bar handle member 64 is coupled to valve plate 66, which is positioned within housing 82 of flush valve member 40. When valve plate 66 completely occludes lower portion 62 of receptacle member 50, flush valve member 40 is in the closed position. When flush valve member 40 is in the closed position, pet waste 94 and the volume of flushing fluid 96 can be accumulated in receptacle member 50. As T-bar handle member 64 is extracted from neck portion 84 by movement in the direction of arrow 86, valve plate 66 follows, thereby opening lower portion 62. When valve plate 66 is extracted into neck portion 84, and lower portion 62 is no longer occluded, flush valve member 40 is in the open position. When flush valve member 40 is in the open position, accumulated pet waste 94 and the volume of flushing fluid 96 is allowed to pass from receptacle 50, through flush valve member 40, through pipe riser 38, and into sewer line 70 (see FIG. 1). Flush valve member 40, housing 82, neck portion 84, and valve plate 66 may be coated with a conventional lubricant to maintain a fluid-tight seal and provide ease of movement of T-bar handle member 64.

Referring to FIGS. 1A and 1B, the receptacle member 50 is further comprised of a receptacle inlet port 46, 44 for receiving the flushing fluid 96 and delivering the flushing fluid 96, including any detergent or disinfectant additives, into receptacle member 50 for mixing with the pet waste 94. In the preferred embodiment 14, there are two potential inlet ports 46, 44. Port 46 is a female adapter inlet port 46 structured and arranged to receive a male fitting. Port 44 is a male adapter inlet port 44 structured and arranged to be coupled with a female fitting.

In operation, flush valve member 40 is moved into the closed position by pushing T-bar handle member 64 so as to move valve plate 66 from the neck portion 84 of flush valve member 40 so as to occlude lower portion 62. Pet waste 94 is placed into receptacle member 50, typically with the use of a shovel, or other pet waste 94 collecting device. A selected volume of flushing fluid 96, preferably 1.5 gallons or less, is added to receptacle member 50 in a manner such that it mixes with the pet waste 94. The flushing fluid 96 is preferably water from the water supply assembly 88, but can be from another source, such as a garden hose or home water hydrant, but it may include detergent or disinfectant additives, in order to maintain sanitary conditions within apparatus 14. In the preferred embodiment described above, the source of the flushing fluid 96 is independent of receptacle member 50.

After the pet waste 94 and the selected volume of flushing fluid 96 have been added to receptacle member 50, T-bar handle member 64 is extracted from neck portion 84 of flush valve member 40, preferably in a rapid fashion, thereby causing valve plate 66 to be retracted into neck portion 84. When valve plate 66 is retracted into neck portion 84, flush valve member 40 is switched into the open position in which the pet waste 94 and flushing fluid 96 are allowed to flow out of receptacle member 50, through flush valve member 40, through pipe riser 38, and into sewer line 70. Because a selected volume of flushing fluid 96 is accumulated within receptacle member 50 prior to opening flush valve member 40, a siphon-type flushing action is created when flush valve member 40 is moved to the open position, similar to the flushing action present in a conventional toilet.

After the pet waste 94 and flushing fluid 96 have been delivered into sewer line 70, T-bar handle member 64 is pushed back into neck portion 84, thereby switching flush valve member 40 into the closed position.

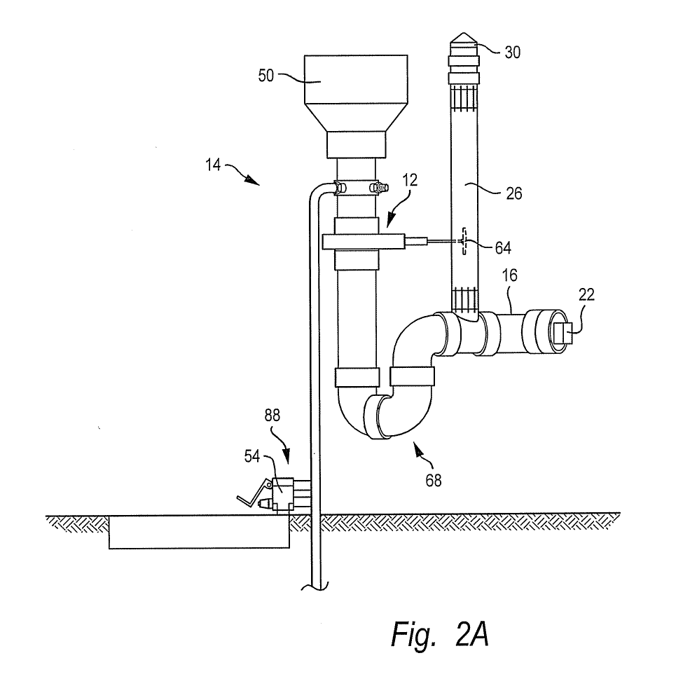

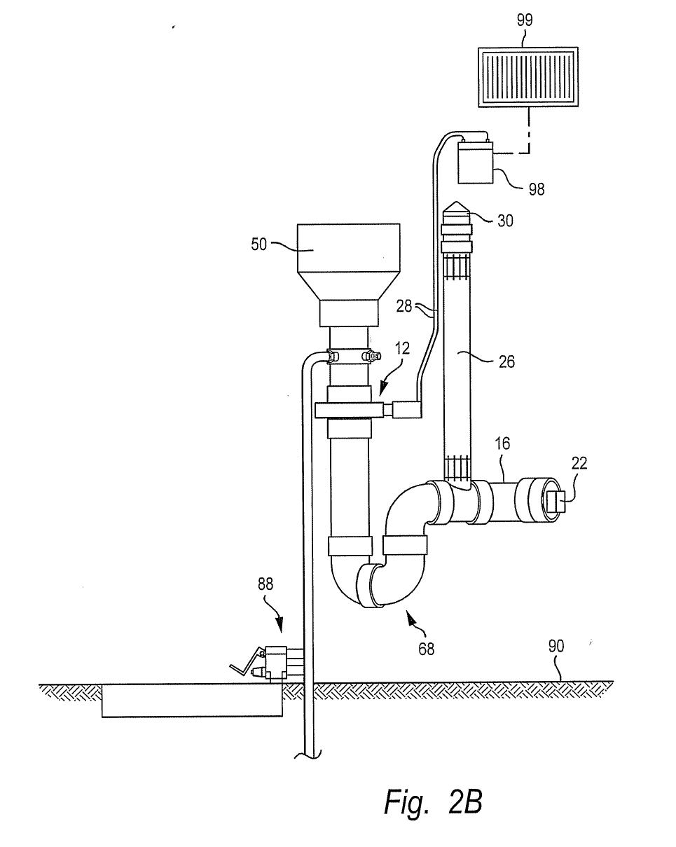

Referring now to FIGS. 2A & 2B in the drawings, alternate embodiments of the present invention are illustrated. As shown, in another aspect of the invention the apparatus 14 may be coupled to an above ground plumbing stub 16. All elements of the embodiment depicted in FIGS. 2A & 2B are identical to the corresponding elements of like numerals in FIGS. 1A & 2B, with the exception that plumbing stub 16 is above ground 90 in FIGS. 2A & 2B and plumbing stub 16 is below ground 90 in FIGS. 1A & 10. Also, plumbing stub 16 is horizontally oriented (in relation to ground 90) in FIGS. 2A & 2B and plumbing stub 16 is vertically oriented (in relation to the ground 90) in FIGS. 1A & 1B.

As shown in FIGS. 1A-2B, the apparatus 14 is further comprised of a foot pedal valve assembly 54. As best shown in FIG. 1A, foot pedal valve assembly 54 is comprised of generally L-shaped foot pedal 61 that pivots about a pin 57, and a valve 59 carried by housing 55. Movement of foot pedal 61 is indicated by arrow 63. Foot pedal 61 is biased in an undepressed position by a conventional spring (not shown). When depressed, foot pedal 61 operates valve member 59 carried by housing 55. Valve member 59 is preferably a one-way valve that will allow fluid flow 96 in only one direction. Valve member 59 has a flushing fluid 96 inlet port 65, and a flushing fluid 96 outlet port 67. Valve member 59 is operable between a closed position and an open position by action of foot pedal 61.

Operation of valve member 59 will be described in more detail below with reference to FIG. 1A. Inlet port 65 of valve member 59 is adapted to receive a flushing fluid 96 supply line 56. Flushing fluid 96 supply line 56 delivers flushing fluid 96 to valve member 59 from a source of flushing fluid 96, preferably a source of pressurized water 96, such as a lawn sprinkler system. A flushing fluid 96 conduit member 52 provides fluid communication between valve member 59 and receptacle inlet port 46 of receptacle 50. Flushing fluid 96 passes from valve member 59, through flushing fluid 96 outlet port 67, through fluid conduit member 52, through receptacle inlet port 46, and into receptacle member 50.

It is another aspect of the invention to provide a method for disposing of pet waste 94 comprising the steps of providing an outdoor pet waste disposal apparatus 14 comprised of a receptacle 50, an inlet conduit 52 coupled to the receptacle 50, a one-way valve 59, a volume of flushing fluid 96, a flushing valve 40, an outlet conduit 38 having a hydrostatic seal 68, said outlet conduit 38 being coupled to the receptacle 50 and a sewer 70; placing a volume of pet waste 94 into said receptacle 50; filling the receptacle with flushing fluid 96; opening the flushing valve 40 to allow the pet waste 94 to exit the receptacle 50 through the outlet conduit 38 into the sewer 70.

In another aspect of said method, the apparatus 14 is comprised of a vent 30.

In another aspect of said method, the apparatus 14 is coupled to a below ground 90 plumbing stub 16.

In another aspect of said method, the apparatus 14 is coupled to an above ground 90 plumbing stub 16.

It should be apparent from the foregoing that an invention having significant advantages has been provided. The apparatus is simple in design and economical to manufacture, making it well adapted for either home use or use in common places outside multi-family dwelling units. The apparatus is quick and easy to install, and can be used on existing homes or buildings, or on new construction. The apparatus prevents cross contamination and conforms to the Uniform Building Code. While the invention is shown in only a few forms, it is not just limited but is susceptible to various changes and modifications without departing from the spirit thereof. The foregoing description of a preferred embodiment of the invention has been presented for the purpose of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention in accordance with the breadth of this disclosure, to which it is fairly, legally, and equitably entitled to be interpreted.

I claim:

1. A pet disposal system comprising:
a receptacle, an inlet conduit having first and second ends, and an outlet conduit in fluid communication with said receptacle; said inlet conduit first end being in fluid communication with said receptacle; said inlet conduit second end being adapted to receive a source of flushing fluid; said inlet conduit comprising a first valve structured and arranged to regulate an ingress of said flushing fluid from said inlet conduit into said receptacle; said outlet conduit comprising a second valve structured and arranged to regulate an egress of flushing fluid from said receptacle; said outlet conduit further comprising a trap structured and arranged to provide a fluid seal; said system being capable of being used to dispose of pet waste.

2. The pet disposal system of claim 1 wherein said system is adapted in such a way as to be capable of being in fluid communication with a plumbing stub.

3. The pet disposal system of claim 1 wherein said trap is underground.

4. The pet disposal system of claim 1 wherein said outlet conduit further comprises a vent.

5. The pet disposal system of claim 1 wherein said first valve may be opened and closed by a user's foot.

6. The pet disposal system of claim 1 wherein said second valve comprises a handle which may be grasped by a user to open and close said second valve.

7. The pet disposal system of claim 1 wherein said second valve may be opened and closed with an electronic activator.

8. The pet disposal system of claim 7 where said second valve is solar powered.

9. The pet disposal system of claim 1, further comprising a sewer line comprising a plumbing stub; and wherein said outlet conduit is in fluid communication with said sewer line.

10. The pet disposal system of claim 1 further comprising a slab positioned in proximity to said first valve such that a user may place a foot on said slab while operating the first valve.

11. The pet disposal system of claim 1 wherein said first valve is a one way valve.

12. The pet disposal system of claim 1 wherein said receptacle is conical in shape such that the receptacle has a larger diameter at a top portion than at a lower portion.

13. A pet disposal system comprising:
a receptacle, an inlet conduit having first and second ends, and an outlet conduit in fluid communication with said receptacle; said inlet conduit first end being in fluid communication with said receptacle; said inlet conduit second end being adapted to receive a source of flushing fluid; said inlet conduit comprising a first valve structured and arranged to regulate an ingress of said flushing fluid from said inlet conduit into said receptacle; said outlet conduit comprising a second valve structured and arranged to regulate an egress of flushing fluid from said receptacle; said outlet conduit further comprising a trap structured and arranged to provide a fluid seal, said trap being underground; said outlet conduit further comprising a vent; said first valve being capable of being opened and closed with a user's foot; said second valve comprising a handle capable of being grasped by a user to open and close said second valve; a sewer line further comprising a plumbing stub in fluid communication with said outlet conduit; said system being capable of being used to dispose of pet waste.

14. A method of disposing of pet waste comprising the steps of:
providing an outdoor pet waste disposal apparatus comprising a receptacle, an inlet conduit coupled to the receptacle, a one way valve, a flushing valve, an outlet conduit having a second valve and a trap, said outlet conduit being coupled to the receptacle;
placing a volume of pet waste into said receptacle;
filling the receptacle with a volume of flushing fluid; and
opening the flushing valve to allow the pet waste to exit the receptacle through the outlet conduit.

15. The method of disposing of pet waste of claim 14 wherein said apparatus is adapted in such a way as to be capable of being in fluid communication with a plumbing stub.

16. The method of disposing of pet waste of claim 14 further comprising a sewer line comprising a plumbing stub; said outlet conduit being in fluid communication with said plumbing stub.
